(19) United States
(12) Patent Application Publication
(10) Pub. No.: US 2018/0374033 A1
(43) Pub. Date: Dec. 27, 2018

(54) SYSTEM AND METHOD FOR A FLOATING FULFILLMENT

(71) Applicant: James E. Beecham, West Palm Beach, FL (US)

(72) Inventor: James E. Beecham, West Palm Beach, FL (US)

(21) Appl. No.: 15/674,821

(22) Filed: Aug. 11, 2017

Related U.S. Application Data
(60) Provisional application No. 62/604,173, filed on Jun. 26, 2017.

(51) Int. Cl. G06Q 10/08; G06Q 30/06

(52) U.S. Cl. CPC G06Q 10/083; B64C 39/024; G06Q 30/0635

(57) ABSTRACT

A method comprising steps: (a) preparing an order comprising a first product and a second product, wherein the order is placed by a user remotely via a software platform on a centralized server; (b) dispatching the order from the centralized server to a first server located in a first warehouse and a second server located in a second warehouse, wherein the first warehouse contains the first product and the second warehouse contains the second product; (c) transporting the first product to a waterborne vessel via a first unmanned aerial vehicle, wherein the waterborne vessel travels along a waterway; (d) transporting the second product to the waterborne vessel via a second unmanned aerial vehicle; (e) combining the first product and second product into a unified package onboard the waterborne vessel; and (f) delivering the unified package at a delivery location via a third unmanned aerial vehicle.

### CROSS-REFERENCE TO RELATED APPLICATIONS

The present application claims priority to U.S. Provisional Application Ser. No. 62/604,173 filed on Jun. 26, 2017 entitled “Floating fulfillment method and system”, the disclosure of which is hereby incorporated in its entirety at least by reference.

### BACKGROUND OF THE INVENTION

### 1. Field of the Invention

The present invention generally relates to deliveries, and more particularly to a system and method for floating fulfillment.

### 2. Description of Related Art

Online orders for physical goods require fulfillment which typically includes delivery of the goods to a delivery location specified by the ordering user. Unfortunately, the current poor state of roads and bridges and other infrastructure, such as in the USA, combined with high traffic rates can contribute to delays in such delivery. Where such transportation for delivery of goods is road-based, it tends to be inefficient, due to delays. In addition, where multiple items are separately routed to delivery site specified, multiple charges are billed to user, which user often views as excessively costly. Thus, the level of satisfaction regarding such delivery of goods is too often low. Furthermore, goods delivery in urban areas traditionally involves delivery trucks traveling crowded roads it necessitate several days to deliver goods. For example, congested roads and reduced speed limits for trucks in urban areas are among the delays encountered.

To improve the efficiency of delivery of goods, and to attempt to lower the cost associated, use of unmanned aerial vehicles (UAVs) has been proposed, and tried at least on a limited scale. However, while use of UAVs for delivery of goods may improve some aspects of delivery, difficulties specific to UAV use are known. For example, governmental rules often restrict where UAVs may fly. The purpose of such rules appears to be to prevent UAV encroachment on airplane flightpaths or the like. These restrictions are typically most prominent in urban areas, the location where delays due to heavy traffic and restricted access by trucks are most prominent as well.

Furthermore, UAVs use for deliveries of goods faces a limitation in distances UAVs may fly under load, due to constraints in such factors as battery power and engine lift and the like. These UAV-associated problems make UAV-associated delivery, especially in urban areas, problematic.

Furthermore, the solution of some delivery services to keep goods close to urban areas by warehousing these goods nearby can be costly to customers. This is because real estate costs within urban areas are typically high. Such high warehouse costs in urban areas must be passed along to customers; hence this high cost is a source of dissatisfaction for users. Even using nearby warehouses to urban area, and even when using truck transport of goods, a single contemporaneous order of multiple goods by a customer is often sourced from multiple warehouses and delivered by multiple trucks over different routes, which often leads to multiple charges to user. This is another cause for users to be dissatisfied.

What is needed is a means to deliver goods more efficiently and more cost-effectively, especially where utilizing UAVs, especially within and near urban areas.

### BRIEF SUMMARY OF THE INVENTION

In one embodiment of the present invention a method is provided, comprising steps: (a) preparing an order comprising a first product and a second product, wherein the order is placed by a user remotely via a software platform on a centralized server; (b) dispatching the order from the centralized server to a first server located in a first warehouse and a second server located in a second warehouse, wherein the first warehouse contains the first product and the second warehouse contains the second product; (c) transporting the first product to a waterborne vessel via a first unmanned aerial vehicle, wherein the waterborne vessel travels along a waterway; (d) transporting the second product to the waterborne vessel via a second unmanned aerial vehicle; (e) combining the first product and second product into a unified package onboard the waterborne vessel; and (f) delivering the unified package at a delivery location via a third unmanned aerial vehicle.

In one embodiment, in step (c), the first product is transported when the waterborne vessel is in a predetermined proximity to the first warehouse, such that the distance the first unmanned aerial vehicle travels is minimized. In another embodiment, in step (d), the second product is transported when the waterborne vessel is in a predetermined proximity to the second warehouse, such that the distance the second unmanned aerial vehicle travels is minimized. In one embodiment, the predetermined proximity between the first and second warehouse and the waterborne vessel is determined via a global positioning system. In one embodiment, the transporting is autonomous and a linked signal via the global positioning system instructs steps (c) and (d) to be performed. In one embodiment, at least one of the first and second warehouses is floating on the waterway. In another embodiment, the delivery location is a location of a road delivery vehicle, wherein the road delivery vehicle is adjacent to the waterway. In yet another embodiment, the delivery location is a location above a ground level, wherein the location has a specialized delivery-receiving element. In another embodiment, the delivery location is in an urban area.

In another aspect of the invention, a system is provided, comprising a centralized Internet-connected computerized appliance having a processor and coupled to a data repository, the processor executing a software platform from a non-transitory medium, the software platform allowing a user to order goods for delivery, the system dispatching the order of goods to a plurality of servers, wherein the plurality of servers are located at a plurality of warehouses respectively, wherein the goods are located in at least one of the plurality of the warehouses, the system autonomously transporting the goods to a waterborne vessel via at least one transport unmanned aerial vehicle, and the system autonomously delivering the goods to a delivery location via a delivery unmanned aerial vehicle.

In one embodiment, the goods are transported when the waterborne vessel is in a predetermined proximity to the at least one of the plurality of warehouses, such that the distance the at least one transport unmanned aerial vehicle travels is minimized. In one embodiment, the predetermined proximity is determined via a global positioning system. In another embodiment, the plurality of warehouses is located in rural locations and the delivery location is in an urban area. In yet another embodiment, the waterborne vessel travels along a waterway adjacent to the urban area.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a flowchart for a method for a floating fulfillment according to an embodiment of the present invention.

FIG. 2 is a diagram illustrating a system for a floating fulfillment according to an embodiment of the present invention.

FIG. 3 is a diagram of a computer network system according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for a floating fulfillment.

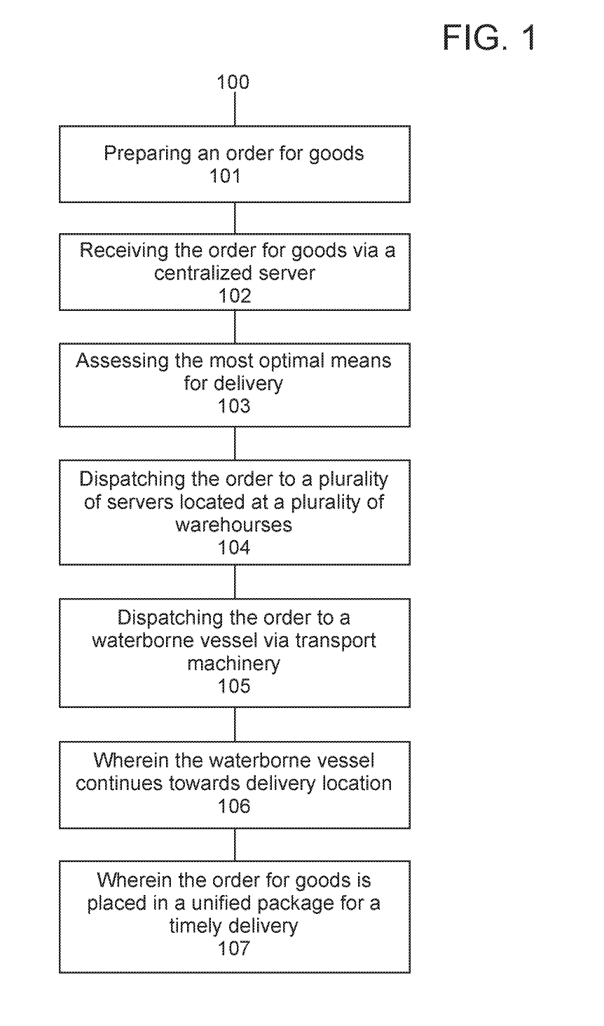

FIG. 1 is a flowchart for a method 100 of a floating fulfillment according to an embodiment of the present invention. Referring now to FIG. 1, the method is shown. First, in step 101, an order for goods is prepared. Specifically, the order for goods is entered online by a user as well known in the art, such as electronically using a computerized device via a software platform. In one embodiment, in steps 102 and 103, a centralized server via the platform software receives the order for goods and assesses the most efficient or optimal means to deliver the goods ordered by the user. In one embodiment, the most efficient means to deliver the goods is to utilize a waterborne vessel to be used as an intermediate repackage site. The most efficient means of delivery is determined by the delivery location of the user, which will be described in further detail below.

In step 104, the order is dispatched to a plurality of servers located at a plurality of warehouses respectively. For instance, in one embodiment, the order is dispatched from the centralized server to a first and a second server of the plurality of servers to a first and second warehouse of the plurality of warehouses. In step 105, each server at each respective warehouse instructs transport machinery to dispatch the order to a waterborne vessel when the waterborne vessel is in close proximity to the each respective warehouse. Numerous scenarios are possibly, however, assuming the order comprises two products, product A and product B, wherein product A is located at the first warehouse and product B is located at the second warehouse, the first warehouse processes instruction to dispatch product A to the waterborne vessel when the waterborne vessel is nearest to the first warehouse. Similarly, the second warehouse processes transport instructions to dispatch product B to the waterborne vessel when the waterborne vessel is nearest to the second warehouse. In one embodiment, the waterborne vessel is a floating barge. In another embodiment, the floating barge is motorized, typically located on a waterway in the vicinity of an urban area, such as a river or canal or lake or oceanfront or similar continuous body of water coursing past or through or located beside a city. The motorized barge is typically employed in a mobile fashion, such as cruising under power to carry out a regular course or circuit. This circuit is typically from a location on the said waterway within a relatively rural area to a contiguous area of the said waterway in a more urban area of same of adjoining waterway and back. In one embodiment, the location of each warehouse in proximity to the barge is monitored via GPS and tracking software as well known in the art.

In one embodiment, the transport machinery comprises an unmanned aerial vehicle (UAV). The waterborne vessel has at least one landing/drop-off area for the unmanned aerial vehicle. Once the delivery to the waterborne vessel is made, the transport machinery returns to the respective warehouse. In step, 106, the waterborne vessel continues along waterway towards the urban area, i.e. the delivery location. In step 107, the order for goods is configured in a unified package for a timely delivery to the user. In embodiments as described above, wherein the order consists of product A and B, the unified package includes package A and B. In one embodiment, machinery, such as barge-located machinery, assembles the order into the unified package, in a manner well known in the art. In one embodiment, delivery transport machinery, such as an unmanned aerial vehicle, transports the unified package to the user for delivery. In another embodiment, a waterborne vehicle subunit delivers the order to the shore. In one embodiment, GPS is used to determine when the waterborne vessel is in close proximity to the delivery location. It should be understood, that although the best mode example describes two packages A and B, the order may contain any number of packages without departing from the spirit and scope of the invention.

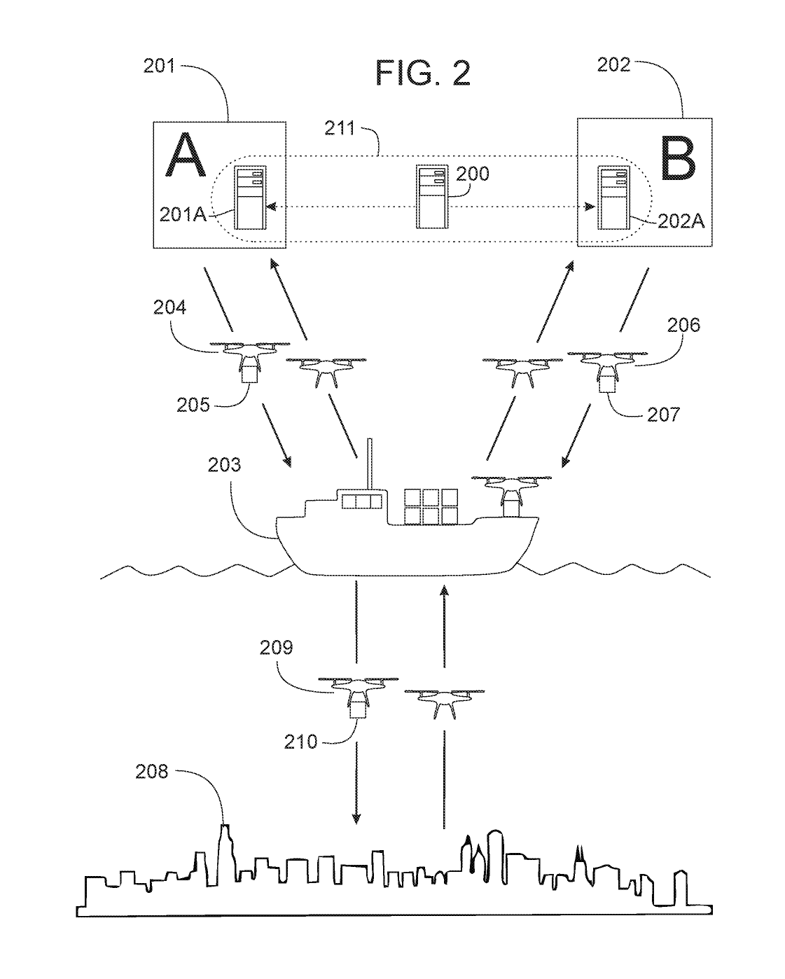

FIG. 2 is a diagram illustrating a system for a floating fulfillment according to an embodiment of the present invention. Referring now to FIG. 2, the system is illustrated. The system comprises a plurality of warehouses, such as warehouse A 201 and warehouse B 202 as used in the previous example. In one embodiment, the warehouses A and B are connected to a centralized server 200 via a first and a second server 201A/202A respectively over the Internet 211. The specific network diagram will be described below.

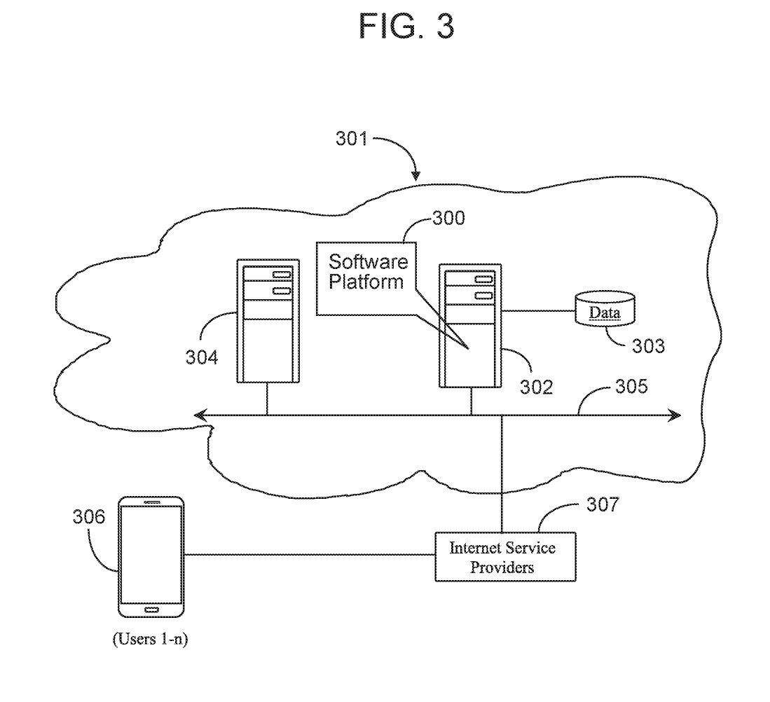

As previously mentioned, a user places an order for goods via a software platform 300 (FIG. 3) that is received by the centralized server. The order for goods is then sent to the plurality of warehouses, in this case, first server 201A and second server 202A located in warehouse A and B respectively. It should be understood, that although two warehouses are illustrated any number of warehouses may be present.

As described in the method of FIG. 1, the goods or a portion of the goods is dispatched from each warehouse of the plurality of warehouses via unmanned aerial vehicles to a waterborne vessel 203. In the best mode example, a first unmanned aerial vehicle 204 carrying package A 205 is dispatched to the waterborne vessel when the waterborne vessel is in close proximity to warehouse A. After delivering package A, the first unmanned aerial vehicle is returned to the warehouse as illustrated. Similarly, a second unmanned aerial vehicle 206 carrying package B 207 is dispatched to the waterborne vessel when the waterborne vessel is in close proximity to warehouse B. After delivering package B, the second unmanned aerial vehicle is returned to the warehouse as illustrated.

In one embodiment, the order for goods is placed in a unified package 210, and then dispatched for a timely delivery to the user in urban area 208 via a third unmanned aerial vehicle 209. In the current embodiment, the unified package includes the content of package A and B. After delivering the unified package to the user, the third unmanned aerial vehicle is returned to the waterborne vessel as illustrated. In one embodiment, GPS is used to determine when the waterborne vessel is in close proximity to the delivery location of the urban area. GPS is also used to determine the distance and location of the waterborne vessel to the plurality of warehouses.

Typically the plurality of warehouses is offset from the urban area a distance along the waterway in which the waterborne vessel travels, and often warehouses are offset from a waterfront location. Nevertheless, the plurality of warehouses is within efficient unmanned aerial vehicle travel distances to the waterborne vessel. Typically, each of the plurality of warehouses is located in relatively more rural area as compared to the relatively more urban location of user/delivery site. By virtue of the rural warehouse locations, lower cost of warehousing is realized and contributes to lower delivery costs to user.

In one embodiment, the waterborne vessel, such as a self-powered motorized barge, has facilities to receive delivery of packages from the plurality of warehouses, then to correlate delivered goods to ordered goods by a specific user, then where appropriate to combine a first delivered good package for a specific user contemporaneous order to form a larger combination or unified load of packages/goods by combining with a second contemporaneously unmanned aerial vehicle delivered good for the same user contemporaneous order. Then the unified load of combined goods/packages is subsequently transported to user-specified location via an unmanned aerial vehicle or waterborne vehicle subunit.

In one embodiment, as previously described, the unmanned aerial vehicles from the plurality of warehouses drop off goods at a waterborne vessel and the unmanned aerial vehicles return to their respective warehouse. Meanwhile, after multiple packages from a single contemporaneous order by a user are unified, i.e. typically stacked together onboard the waterborne vessel by machinery, as is well-known in the art, then a waterborne vessel-located and separate unmanned aerial vehicle is allocated from a plurality of unmanned aerial vehicles located on the waterborne vessel. This unmanned aerial vehicle attaches to the unified load or stack of packages and prepares to deliver the order. In one embodiment, the launch of the unmanned aerial vehicle is triggered by a GPS linked signal from onboard computer. In one embodiment, this launch signal occurs as the waterborne vessel proceeds in circuit until a sufficient proximity to user-specified urban delivery site. The sufficient proximity is a predetermined proximity such that the transport time from the respective warehouses to the waterborne vessel and/or the transport time from the waterborne vessel to the final delivery site is minimized/optimized.

In one embodiment, as the assembly of ordered packages is occurring onboard, the waterborne vessel travels across the waterway towards the urban area. In one embodiment, when distance to delivery locale is correct and in compliance with governmental limitations regards unmanned aerial vehicle flights, the unmanned aerial vehicle flight leaves the waterborne vessel carrying the unified order. The unmanned aerial vehicle flight enables completion of unified order delivery, which will be described in further detail below. In one embodiment, the unmanned aerial vehicle then returns to the waterborne vessel, which has moved further along its circuit.

It is a particular advantage of the present invention, that GPS signaling is used to alert a warehouse server of the plurality of warehouses, regarding data of the proximity of the approaching waterborne vessel. This alert enables the coordination via servers such that the warehouse has the order ready for an unmanned aerial vehicle delivery to the waterborne vessel when in a predetermined proximity. GPS signal of proximity to warehouse of approaching waterborne vessel is utilized automatically in process to dispatch the unmanned aerial vehicles of the plurality of warehouses to the waterborne vessel. Similarly, as the loaded waterborne vessel travels to the urban area, GPS signaling is used via servers to automatically alert an onboard waterborne vessel system to have unmanned aerial vehicles and/or waterborne vessel subunits ready and then to launch when the waterborne vessel is in proximity to the delivery sites. That is, the launch of unmanned aerial vehicles and/or waterborne vessel subunits to various delivery sites with various unified loads of ordered goods is automatically enabled.

Among the advantages of the prevent invention are the decreased cost of warehousing as previously described, and that waterborne traffic route is configured so as to allow unmanned aerial vehicles access to urban area without the unmanned aerial vehicles traversing in restricted areas. Further advantages are utilized by virtue of floating intermediate repacking facility allowing simultaneous delivery of multiple products, thus being more convenient to user in timely delivery at lower cost.

FIG. 3 is a diagram of a computer network system 301 according to an embodiment of the present invention. Referring now to FIG. 3, the computer network system is illustrated. The Internet-connected system comprises one or more Internet-connected servers 302 having one or more processors executing a software platform 300 from non-transitory media. In one embodiment, the software platform enables online order of goods as previously described. Server 302 is connected to a data repository 303, which may be any sort of data storage known in the art. The system further comprises a third party Internet-connected server 304 connected to Internet backbone 305. Although one third party Internet-connected server 304 is shown, it is understood that potentially millions of other similar servers are connected to the Internet via Internet backbone 305. A number of users (1-n) 306 on a computerized device, such as a personal computer or mobile computer are connected to the Internet-connected server via an Internet service provider (ISP) 307, allowing users 306 to access the software platform. In the best mode embodiment, the one or more Internet-connected servers include the centralized server and the servers located in the plurality of warehouses.

Although the invention has been described in considerable detail in lane a specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For example, as part of the final step of unified load of goods delivery, the delivering unmanned aerial vehicles is envisioned to optionally deliver the order onto a basket attached to a waterfront located autonomous motorized vehicle (AMV). Such AMV is typically a narrow vehicle, such as a three wheeled motorcycle type vehicle. Such narrow vehicle is thus enabled to drive along urban roads with ease and make good time to deliver goods at user-specified delivery site. Said AMV is envisioned to proceed, for example, to the building address of the delivery site specified by ordering user, and there the building doorman optionally retrieves package from said basket and doorman optionally then places said package onto a specialized component of the building for receiving delivery, such as a purpose-built dumbwaiter/elevator. Said dumbwaiter/elevator elevates said unified load up to the ordering user's floor/apartment. Alternatively, said elevation at delivery site of said unified load can be via delivering unmanned aerial vehicle signaled from the AMV.

In the case of delivering unmanned aerial vehicle elevation of said unified load, this typically occurs along the outside of the building and to an apartment window or balcony above the ground level of the ordering user's apartment where is located a specialized delivery-receiving aspect. Such aspect can be an open-to-the-air net with homing beacon attached to guide and instruct the unmanned aerial vehicle, as is well known in the art. Furthermore, it is envisioned that at least one warehouse of the instant invention is optionally a container ship moored in harbor adjacent, or a container train car open on a rail siding adjacent to said waterway, or a container truck parked and open in a rural parking facility adjacent to said waterway. Goods from these vehicles are envisioned to be carded by delivering unmanned aerial vehicle to the waterborne vessel.

Further, it is envisioned that a wide variety of goods are thus transportable including food such as snacks or individual ingredients or beverages or prepared meals, and such as pharmaceuticals, such as nutritional supplements, such as clothes, shoes, cosmetics, jewelry, small household items, and such as rented small items of common or uncommon type, and such as emergency equipment or clean water as for use during anticipated upcoming storms, and the like of common small goods.

It is envisioned that delivery of goods herein can be based on earlier subscription by user to said delivery service for said goods, such as fulfillment of magazine subscription and other common subscription-based goods, and the like.

Furthermore, it is envisioned that, optionally, the intermediate water vehicle is an unmanned autonomous GPS-linked computer-guided fast boat, as is well-known in the art.

Although one embodiment of the present invention describes unmanned aerial vehicles operating autonomously, it should be understood that due to federal regulations remote pilots may be required to operate the unmanned aerial vehicles in one embodiment. As federal regulations change, the present invention may be modified without departing from the spirit and scope of the invention. Furthermore, “autonomous” used herein may indicate full autonomous, semi-autonomous, or remotely guided, at least in part. Likewise, any vehicle, vessel, aerial, road-vehicle or otherwise may be autonomous, manned, or operated remotely without departing from spirit and scope of the invention.

Reference to “first,” “second,” “third,” and etc. members throughout the disclosure (and in particular, claims) are not used to show a serial or numerical limitation but instead are used to distinguish or identify the various members of the group.

What is claimed is:

1. A method comprising steps:
(a) preparing an order comprising a first product and a second product, wherein the order is placed by a user remotely via a software platform on a centralized server;
(b) dispatching the order from the centralized server to a first server located in a first warehouse and a second server located in a second warehouse, wherein the first warehouse contains the first product and the second warehouse contains the second product;
(c) transporting the first product to a waterborne vessel via a first unmanned aerial vehicle, wherein the waterborne vessel travels along a waterway;
(d) transporting the second product to the waterborne vessel via a second unmanned aerial vehicle;
(e) combining the first product and second product into a unified package onboard the waterborne vessel; and
(f) delivering the unified package at a delivery location via a third unmanned aerial vehicle.

2. The method of claim 1, wherein in step (c), the first product is transported when the waterborne vessel is in a predetermined proximity to the first warehouse, such that the distance the first unmanned aerial vehicle travels is minimized.

3. The method of claim 2, wherein in step (d), the second product is transported when the waterborne vessel is in a predetermined proximity to the second warehouse, such that the distance the second unmanned aerial vehicle travels is minimized.

4. The method of claim 3, wherein the predetermined proximity between the first and second warehouse and the waterborne vessel is determined via a global positioning system.

5. The method of claim 4, wherein the transporting is autonomous and a linked signal via the global positioning system instructs steps (c) and (d) to be performed.

6. The method of claim 1, wherein at least one of the first and second warehouses is floating on the waterway.

7. The method of claim 1, wherein the delivery location is a location of a road delivery vehicle, wherein the road delivery vehicle is adjacent to the waterway.

8. The method of claim 1, wherein the delivery location is a location above a ground level, wherein the location has a specialized delivery-receiving element.

9. The method of claim 1, wherein the delivery location is in an urban area.

10. A system comprising:
a centralized Internet-connected computerized appliance having a processor and coupled to a data repository, the processor executing a software platform from a non-transitory medium, the software platform allowing a user to order goods for delivery, the system dispatching the order of goods to a plurality of servers, wherein the plurality of servers are located at a plurality of warehouses respectively, wherein the goods are located in at least one of the plurality of the warehouses, the system autonomously transporting the goods to a waterborne vessel via at least one transport unmanned aerial vehicle, and the system autonomously delivering the goods to a delivery location via a delivery unmanned aerial vehicle.

11. The system of claim 10, wherein the goods are transported when the waterborne vessel is in a predetermined proximity to the at least one of the plurality of warehouses, such that the distance the at least one transport unmanned aerial vehicle travels is minimized.

12. The system of claim 11, wherein the predetermined proximity is determined via a global positioning system.

13. The system of claim 10, wherein the plurality of warehouses is located in rural locations and the delivery location is in an urban area.

14. The system of claim 13, wherein the waterborne vessel travels along a waterway adjacent to the urban area.

15. A system for delivering goods to a delivery location comprising:
at least one rural located warehouse contiguous to a waterway, wherein the at least one rural located warehouse contains the goods for delivery, wherein the delivery location is located in an urban area contiguous to the waterway;
a waterborne delivery vessel configured to travel the waterway;
at least one transport unmanned aerial vehicle configured to transport the goods from the at least one rural located warehouse to the waterborne delivery vessel; and
an unmanned delivery vehicle configured to deliver the good to the delivery location.

16. The system of claim 15, wherein the unmanned delivery vehicle is an unmanned delivery aerial vehicle, wherein the unmanned delivery aerial vehicle is configured to travel from the waterborne delivery vessel to the delivery location when the waterborne delivery vessel is in a predetermined proximity to the urban area.

17. The system of claim 15, wherein the unmanned delivery vehicle is adjacent to the waterway and the unmanned delivery vehicle is a road delivery vehicle configured to receive the goods from an unmanned delivery aerial vehicle configured to travel from the waterborne delivery vessel to the unmanned delivery vehicle.

18. The system of claim 17, wherein the road delivery vehicle is an autonomous motorized vehicle.
